(19) United States
(12) Patent Application Publication
(10) Pub. No.: US 2006/0244994 A1
(43) Pub. Date: Nov. 2, 2006

(54) Shared print server control program and shared print server control method

(75) Inventor: Makoto Konnai, Tokyo-to (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/375,262

(22) Filed: Mar. 15, 2006

(30) Foreign Application Priority Data
Mar. 15, 2005 (JP) 2005-73537

(51) Int. Cl. G06F 3/12

(52) U.S. Cl. 358/1.15; 709/203

(57) ABSTRACT

A shared print server control program and a shared print server control method are disclosed. In addition to a standard spooler included in the operating system mounted on the server for managing the printing jobs based on the shared printer function, an additional spooler for assisting in the management of printing jobs is arranged on the server. The additional spooler, without waiting for the end of the processing operation of the previously received printing jobs, sequentially receives all the printing jobs transmitted from the client, after which the communication with the client is cut off without delay or immediately, thereby realizing the operation of a shared printer system.

### CROSS-REFERENCE TO RELATED APPLICATION

This subject is related to subject matter disclosed in Japanese Patent Application No. 2005-73537 filed on Mar. 15, 2005 in Japan to which the subject application claims priority under Paris Convention and which is incorporated herein by reference.

### BACKGROUND OF THE INVENTION

1. Field of the Invention

This invention relates to a shared print server control program and a shared print server control method for improving a shared print server control function included in the basic software, i.e. the operating system for managing the whole computer system.

2. Related Background Art

The current version Mac OS X® of the basic software, i.e. the operating system (OS) mounted on the personal computers Macintosh®, Power Macintosh®, Power Mac®, iMac®, eMac®, Mac mini®, iBook® and power Book® supplied by Apple Computer, Inc.® includes the function called “the shared printer” used in the printing process.

In using the “shared printer” function, a predetermined setting is carried out through a user interface (UI) provided by the operating system mounted on the Macintosh personal computer functioning as a print server (hereinafter referred to as the “server”). Then, the printing job transmitted from the other Macintosh personal computers (hereinafter referred to as the “clients”) connected to the server through a network is received by the server, and using a printer connected locally or through a network to the server, the printing based on the printing job is executed.

FIG. 5 is a block diagram showing a shared printer system configured of a server connected with a printer and a client connected to the server through a network.

The server 3 is connected with a printer 4 locally or through a network. Also, the server 3 is connected with a client 1 through the network 2. In FIG. 5, only one client 1 connected to the server 3 through a network is shown for simplification. Normally, however, a plurality of clients 1 are connected.

A file to be printed such as a document file or an image file is prepared or edited by an arbitrary application software 11 installed in the client 1, and a print execution instruction is input. Then, based on the image data generated by the application software 11, a graphic engine 13 produces a PDF file 14 for each page.

On the other hand, the application software 11 outputs a print request to a print API (application program interface) 12, and in response to this instruction, the print API 12 prepares a query or a job ticket to give a print request to the shared printer system, which is attached to the PDF file 14.

The client spooler (CUPS (common UNIX printing system)®) 15 included in the operating system mounted on the client 1 to manage the printing job based on the shared printer function transmits the PDF file 14 making up the printing job to the server 3 through the network 2 together with a query or a job ticket.

The standard spooler (CUPS) 31 included in the operating system mounted on the server 3 to manage the printing job based on the shared printer function, upon receipt of printing jobs from the client 1 through the network 2, converts the printing jobs sequentially to the raster data, which is transmitted to a back-end unit 32, which in turn outputs the raster data to the printer 4 as print data, and the printer 4 executes the printing operation based on the print data.

The above-mentioned shared printer system configured based on the standard function of “Mac OS X” is described in detail in the following official Web site of Apple Computer, Inc:

“About the Mac OS X Printing System”(http://developer.apple.com/documentation/Printing/Conceptual/About_MacOSX_Printing/Index.html or http://developer.apple.com/documentation/Printing/Conceptual/About_MacOSX_Printing/prtfund.pdf)

In the shared printer system configured based on the standard function “Mac OS X” as described above, even during the operation of the printing job in the server 3, the communication connection between the server 3 and the client 1 is maintained, and in the case where some error occurs during the period before the end of the operation of the printing job, the error information is notified to the client 1.

A feature of this shared printer system lies in that the error information is displayed through a user interface included in the client 1 conveniently unlike Linux® using the CUPS as a printing frame work.

The shared printer system based on the standard function “Mac OS X”, however, has the following inconvenience due to the fact that the communication connection between the server 3 and the client 1 is maintained until the end of the operation of the printing job.

First, in the case where a plurality of clients try to transmit a plurality of printing jobs to the server, for example, each client cannot transmit a succeeding printing job before the printing job previously transmitted by the particular client is completely executed. Therefore, an emergency printing, if any, cannot be executed rapidly.

Secondly, after a printing job is transmitted from the client to the server, the communication connection between them is maintained and a job window indicating the progress of the printing job continues to be displayed on the client monitor until the end of the operation of the particular printing job. Even after the printing job is completely transmitted from the client to the server, therefore, the power of the client cannot be switched off until the end of the operation of the printing job.

Due to the inconveniences as described above, in the case where a plurality of clients try to transmit a plurality of printing jobs to the server at the same time and the plurality of the printing jobs are stagnated on the server, the usability and convenience of the client are extremely deteriorated.

Although this problem is caused by TIOGA which is a printing framework of “Mac OS X”, a similar problem is posed by a version in which the printing framework is replaced with an open source software CUPS.

Therefore, the above-mentioned problem is desirably solved by the improvement of the printing frame of “Mac OS X” in vain.

The printing framework of “Mac OS X”, however, is due to the design policy of “Mac OS X”, and should not be arbitrarily altered by vendors, etc.

A solution to the problem is desired strongly especially from the high-end users required to process a multiplicity of printing jobs, and a measure to solve the problem on the part of vendors without changing the printing framework of “Mac OS X” is desired.

### SUMMARY OF THE INVENTION

The object of this invention is to provide a shared print server control program and a shared print server control method in which the printing job can be processed smoothly and rapidly as viewed from the client in a shared printer system without changing the standard function and the printing framework of the operating system.

According to the shared print server control program of the present invention, there is provided a shared print server control program used for a shared printer system including a server connected with a printer and at least one client connected to the server through a network, realizing an operation of the shared printer system in such a manner that:

an additional spooler for assisting in the management of printing jobs is arranged on the server in addition to a standard spooler included in the operating system mounted on the server for managing the printing jobs based on the shared printer function; and

the additional spooler, upon sequential receipt of all the printing jobs transmitted from the client, cuts off the communication connection with the client without waiting for the end of the processing operation of the previously received printing jobs.

The additional spooler sequentially may transfer the received printing jobs to the standard spooler.

Only one of the standard spooler and the additional spooler may be recognized exclusively as viewed from the client side.

The shared printer function of the operating system may be set in an invalid state at the time of installing or starting the shared print server control program.

The validity or invalidity of the shared printer function of the operating system may be monitored at the time of starting the shared print server control program.

Upon detection of the validity of the shared printer function of the operating system, the communication function of the additional spooler may be invalidated.

upon detection of the invalidity of the shared printer function of the operating system, the communication function of the additional spooler may be validated.

After starting the shared print server control program, the validity or invalidity of the shared printer function of the operating system may be continuously monitored.

Upon detection of the validity of the shared printer function of the operating system, the communication function of the additional spooler may be invalidated.

Upon detection of the invalidity of the shared printer function of the operating system, the communication function of the additional spooler may be validated.

The additional spooler may monitor the printer status after starting the processing operation of a printing job and upon occurrence of a printer error during the processing operation of the printing job, the error information based on a predetermined protocol may be notified to the client installed with a predetermined resident program.

According to the shared print server control method of the present invention, there is provided a shared print server control method used for a shared printer system including a server connected with a printer and at least one client connected to the server through a network, comprising the steps of:

arranging on the server an additional spooler for assisting in the management of printing jobs in addition to a standard spooler included in the operating system mounted on the server for managing the printing jobs based on the shared printer function;

the additional spooler sequentially receiving all the printing jobs transmitted from the client to the server without waiting for the end of the processing operation of the previously received printing jobs; and

cutting off the communication connection with the client without delay after the additional spooler has sequentially received all the printing jobs transmitted from the client.

The shared print server control method may further comprise the step of:

the additional spooler sequentially transferring the received printing jobs to the standard spooler.

The shared print server control method may further comprise the step of:

the additional spooler monitoring the printer status after starting the processing of a printing job and upon occurrence of an error in the printer during the processing of the printing job, notifying the error information in accordance with a predetermined protocol to the client installed with a predetermined resident program.

Only one of the standard spooler and the additional spooler is exclusively recognized as viewed from the client.

### BRIEF DESCRIPTION OF THE DRAWINGS

FIG. 1 is a block diagram showing a shared printer system configured of a shared print server control program and a shared print server control method according to this invention;

FIG. 2 is a flowchart showing the steps of the operation of monitoring the “shared printer” function of the operating system at the time of starting the shared print server control program according to the invention;

FIG. 3 is a flowchart showing the steps of operation of detecting whether the “shared printer” function is valid or not in changing the setting of the “shared printer” function of the operating system and correspondingly changing the setting of the shared print server control program according to the invention;

FIG. 4 is a flowchart showing the steps of operation to notify the error information to the client from the server in the shared print server control program and the shared print server control method according to this invention; and

FIG. 5 is a block diagram showing a shared printer system configured of a server connected with a printer and a client connected to the server through a network.

### DETAILED DESCRIPTION OF THE EMBODIMENTS

The shared print server control program and the shared print server control method according to an embodiment of the invention are described below with reference to the drawings.

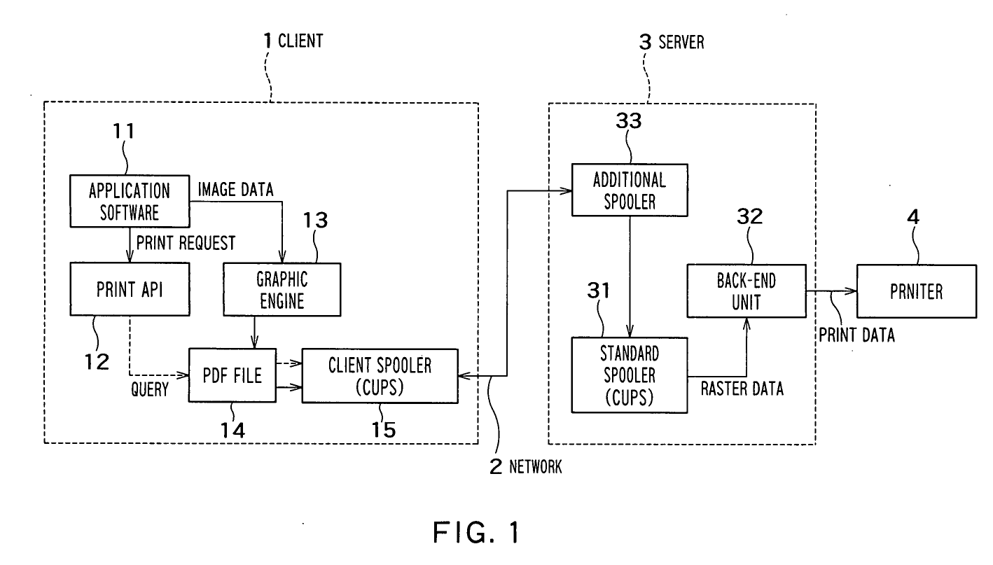

FIG. 1 is a block diagram showing a shared printer system configured of a shared print server control program and a shared print server control method according to this invention.

The shared printer system comprises a server 3 connected to a printer 4 locally or through a network and a client 1 connected to the server 3 through the network 2. In FIG. 1, only one client 1 connected to the server 3 through the network is shown for simplification. Normally, however, a plurality of clients 1 are connected.

The steps of operation before the transmission of a printing job from the client 1 to the server 3 are similar to those of the conventional shared printer system. First, a file such as a document file or an image file to be printed is created or edited by an arbitrary application software 11 installed in the client 1, and a print execution instruction is input. Then, based on the image data created by the application software 11, a graphic engine 13 produces a PDF file 14 for each page.

The application software 11, on the other hand, issues a print request to a print API 12, which in turn produces a query or a job ticket for giving a print request to the shared printer system and attaches it to the PDF file 14.

A client spooler (CUPS) 15 included in the operating system of the client 1 to manage the printing job based on the “shared printer” function transmits the PDF file 14 making up a printing job, together with the query and the job ticket, to the server 3 through a network 2.

In the shared printer system used with the shared print server control program and the shared print server control method according to this invention, an additional spooler 33 for assisting the printing job management is included in the server 3 in addition to the standard spooler (CUPS) 31 for managing the printing job based on the “shared printer” function.

Assume that a plurality of printing jobs are transmitted from a plurality of clients 1 to the server 3. The additional spooler 33 on the server 3 based on the shared print server control program and the shared print server control method according to this invention sequentially receives all the printing jobs without waiting for the end of the processing of the previously received printing jobs, cuts off the communication connection with each client 1 without delay or immediately and sequentially transfers a plurality of the received printing jobs to the standard spooler 31.

The additional spooler 33 receives all the printing jobs sequentially transmitted from the clients 1 without waiting for the end of the processing of the previously received printing jobs. The client 1 desirous of transmitting a plurality of printing jobs, therefore, while printing jobs are being transmitted also from other clients 1, can transmit the particular plurality of printing jobs rapidly without waiting for the end of the processing of the printing jobs previously transmitted by him/her. Thus, the transmission of an emergency printing job, if any, can be rapidly completed.

Also, the additional spooler 33, after sequentially receiving all the printing jobs transmitted from a given client 1, cuts off the communication connection with the particular client 1 without delay or immediately, and at the same time, the job window thus far displayed on the monitor of the particular client 1 disappears. Therefore, each client 1, upon complete transmission of a plurality of printing jobs, is released from the communication connection with the server 3 without waiting for the complete processing of all the printing jobs transmitted from the particular client 1. After complete transmission of the printing jobs, therefore, the power supply can be turned off immediately. As a result, the user of the client 1, who is desirous of going out or returning home immediately after complete transmission of the printing jobs and can check the actual printing result later, can conveniently turn off the power of the client 1.

In the additional spooler 33, the printing jobs received from the clients 1 through the network 2 and held therein are sequentially transferred to the standard spooler 31 on first-come-first-served basis.

The standard spooler 31 included in the operating system mounted on the server 3 to manage the printing jobs based on the “shared printer” function, upon receipt of printing jobs from the additional spooler 33, converts the printing jobs sequentially into raster data and transmits them to the back-end unit 32, which in turn outputs the raster data as a print data to the printer 4. The printer 4 carries out the printing operation based on the print data.

The shared print server control program and the shared print server control method according to this invention, with the provision of the additional server 33 on the server 3, may operate with a communication protocol equivalent to that of the “shared printer” function included in the operating system mounted on the server 3.

In the case where the “shared printer” function of the operating system remains valid and the standard spooler 31 can be recognizable from the client 1, however, an occupancy conflict may occur between the communication port used in the shared print server control program and the shared print server control method according to the invention on the one hand and the communication port used by the “shared printer” function of the operating system on the other hand, with the result that not only the shared printer system may lose its function but also the function of the operating system may be seriously affected.

In application of the shared print server control program and the shared print server control method according to the invention to the shared printer system, therefore, it is desirable to invalidate the “shared printer” function of the operating system in advance by the user operation or executing the operation script. The “shared printer” function of the operating system, though invalid initially, may be validated by subsequent user operation, and therefore the continuous monitoring is required to confirm whether the “shared printer” function of the operating system is valid or not.

In application of the shared print server control program and the shared print server control method according to the invention to the shared printer system, the “shared printer” function of the operating system is basically invalidated in advance, as described above. At the time of starting the shared print server control program according to the invention, the “shared printer” function of the operating system is monitored as to whether it is valid or not, and after that, the continuous monitoring is required as to whether the “shared printer” function of the operating system is valid or not, and upon detection that the “shared printer” function of the operating system is valid, the communication function of the additional spooler 33 is invalidated, while upon detection that the “shared printer” function of the operating system is invalid, on the other hand, the communication function of the additional spooler 33 is validated.

As viewed from the client 1, only the standard spooler 31 is recognized in the case where the “shared printer” function of the operating system is valid and the communication function of the additional spooler 33 is invalid, while only the additional spooler 33 is recognized in the case where the “shared printer” function of the operating system is invalid and the communication function of the additional spooler 33 is valid.

Specifically, as viewed from the client 1, only one of the standard spooler 31 and the additional spooler 33 is exclusively recognized. As a result, the problem of occupancy conflict between the communication ports can be avoided and the operating inconvenience of the shared printer system can be avoided.

The fact that only one of the standard spooler 31 and the additional spooler 33 is exclusively recognized is only the case as viewed from the client 1. Actually, however, both the standard spooler 31 and the additional spooler 33 assume the operating conditions as described above and perform a predetermined processing operation on the server 3.

A specific method of monitoring to confirm whether the “shared printer” function of the operating system is valid or invalid is explained with reference to an application of the shared print server control program and the shared print server control method according to the invention to the shared printer system.

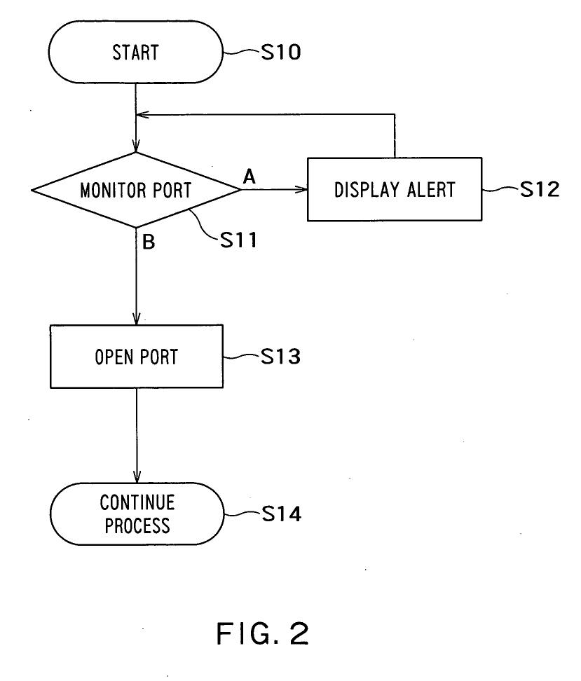

FIG. 2 is a flowchart showing the steps of the operation of monitoring the “shared printer” function of the operating system at the time of starting the shared print server control program according to the invention.

First, at the time of starting the program for carrying out the shard print server control method according to the invention, i.e. the shared print server control program according to the invention (step S10), a predetermined port of the server 3 is monitored to confirm whether it is occupied or not by the “shared printer” function of the operating system included in the server 3 (step S11).

In the case where the predetermined port of the server 3 is occupied by the “shared printer” function of the operating system (case A), an alert against the fact is displayed on the monitor of the server 3 and/or the client 1 (step S12), and without operating the shared print server control program according to the invention, a standby mode is entered to wait until the “shared printer” function of the operating system is invalidated, i.e. until the predetermined port occupied by the “shared printer” function of the operating system is opened.

In the case where the predetermined port of the server 3 is not occupied by the “shared printer” function of the operating system (case B), i.e. in the case where the predetermined port is open (step S13), on the other hand, the process is continued to start and set in operation the shared print server control program according to the invention (step S14).

This monitor operation can avoid the problem of occupancy conflict between the communication ports at the time of starting the shared print server control program according to the invention.

As described above, however, the “shared printer” function of the operating system can be validated at any time by the user operation, and therefore the continuous monitoring is required as to whether the “shared printer” function of the operating system is valid or not.

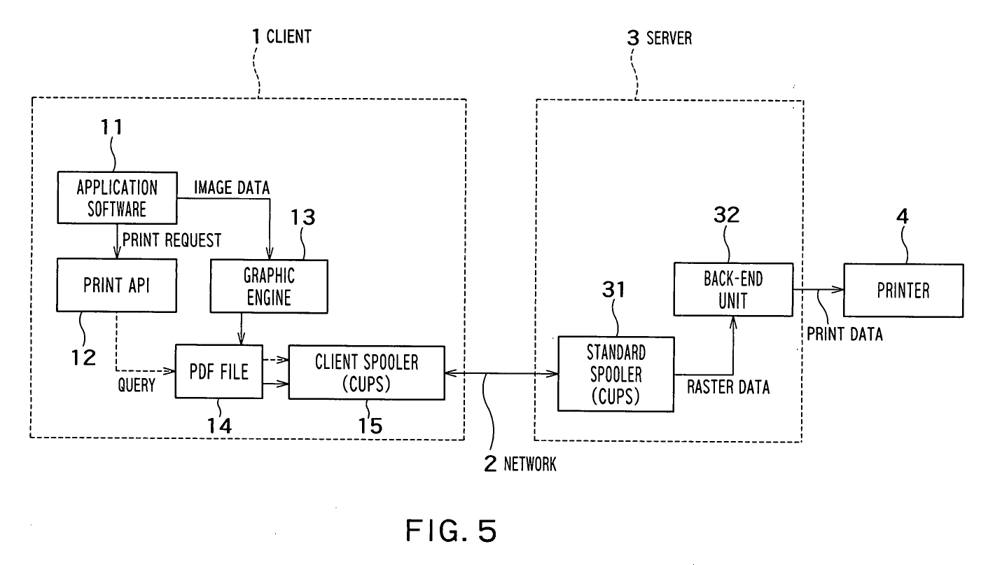

Once the “shared printer” function of the operating system is changed in setting, the setting file of the script (CUPSd.config) accessed by the user interface for setting change is rewritten and the particular script is restarted. By decoding the setting file before restarting the script, therefore, the validity or invalidity of the “shared printer” function of the operating system after restarting the script can be detected in advance. In accordance with this detection result, the setting is changed as to whether the shared print server control program according to the invention (hereinafter referred to also as “this application software” which is different from the “application software 11” shown in FIGS. 1, 5) uses the predetermined port or not, after which this application software is restarted. As a result, the problem of communication port occupancy conflict between the “shared printer” function of the operating system and this application software can be avoided.

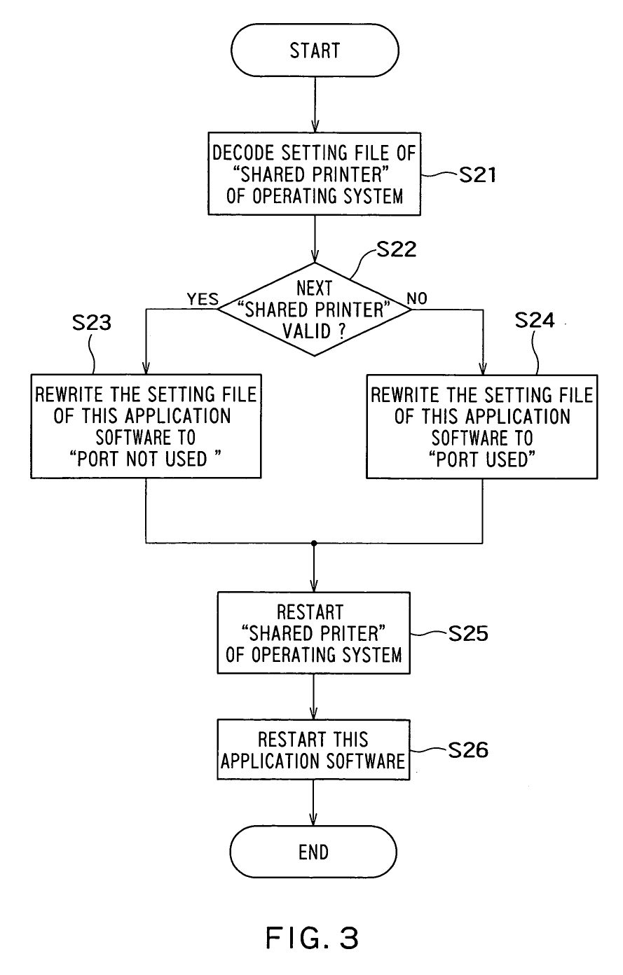

FIG. 3 is a flowchart showing the steps of operation of detecting whether the “shared printer” function is valid or not in changing the setting of the “shared printer” function of the operating system and correspondingly changing the setting of the shared print server control program according to the invention.

Once the setting of the “shared printer” function of the operating system is changed by the user operation, etc., the setting file of the script accessed by the user interface for setting change is rewritten. Before restarting the script, therefore, the setting file is decoded (step S21) and the validity or invalidity of the “shared printer” function of the operating system after next restarting of the script is detected in advance (step S22).

In the case where the result of decoding the setting file shows the prospective validation of the “shared printer” function of the operating system after the next restarting of the script, the setting as to whether the predetermined port is used or not in the setting file of this application software is rewritten to “port not used” (step S23).

In the case where the result of decoding the setting file indicates the prospective invalidation of the “shared printer” function of the operating system after the next restarting of the script, on the other hand, the setting as to whether the predetermined port is used or not in the setting file of this application software is rewritten to “port used” (step S24).

After that, the script for changing the setting of the “shared printer” function of the operating system is restarted (step S25), while at the same time restarting this application software (step S26) thereby to change the setting in accordance with the steps of operation described above.

Consequently, the problem of communication port occupancy conflict between the “shared printer” function of the operating system and this application software can be avoided.

As a preventive measure, the system may be set to invalidate the “shared printer” function of the operating system at the time of installing or starting the shared print server control program according to this invention. Even in the case where such a measure is employed, however, the “shared printer” function of the operating system may be validated by subsequent user operation. Thus, the continued monitoring described above is required.

The additional spooler 33 arranged on the server 3 based on the shared print server control program and the shared print server control method according to this invention, as described above, cuts off the communication connection with a given client 1 without delay or immediately after sequentially receiving all the printing jobs received from the particular client 1.

This communication disconnection process has the advantage of releasing the client 1 conveniently from the communication connection with the server 3 on the one hand, while an error, if occurred, during the processing of the printing job cannot be recognized by the client 1 disadvantageously.

In view of this, the additional spooler 33 arranged on the server 3 based on the shared print server control program and the shared print server control method according to this invention periodically accesses the API of the standard spooler 31 to monitor the printer status, and in the case where an error occurs during the processing of a printing job, notifies the error information to the client 1 in accordance with a predetermined protocol. The client 1 has installed therein a predetermined resident program beforehand whereby the error information can be received and displayed in accordance with the predetermined protocol.

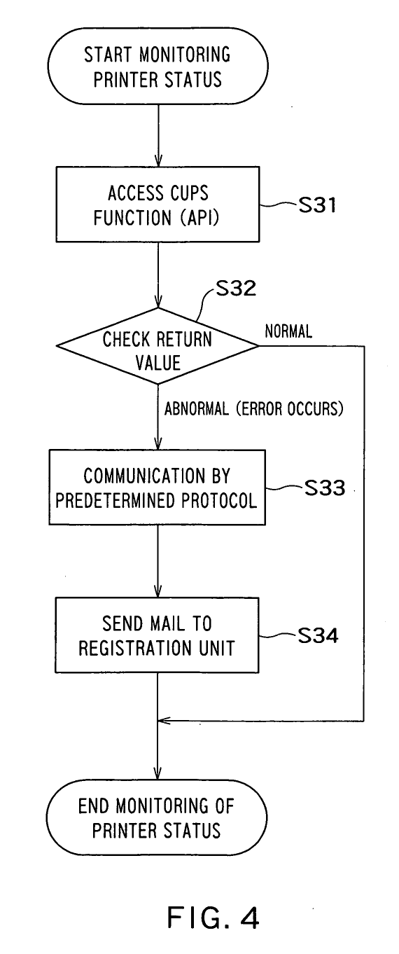

FIG. 4 is a flowchart showing the steps of operation to notify the error information to the client from the server in the shared print server control program and the shared print server control method according to this invention.

In the case where a printing job is transmitted from the client 1 to the server 3 while the program for carrying out the shared print server control method according to the invention, i.e. the shared print server control program according to the invention is operating, the printer status begins to be monitored.

The additional spooler 33 arranged on the server 3 based on the shared print server control program and the shared print server control method according to this invention periodically accesses the CUPS function providing the API of the standard spooler 31 (step S31) and checks the return values thereof (step S32).

The access of the API (CUPS function) of the standard spooler 31 and the check of the return values thereof is carried out periodically at predetermined time intervals till the end of the processing operation of the printing job, and in the case where all the return values are normal, the printer status ceases to be monitored.

In the case where the return value is abnormal at a given time point, i.e. an error occurs, the communication by a predetermined protocol is conducted (step S33), and by sending a mail to a registration unit or otherwise, the error information is notified (step S34). The error information is normally notified to the client 1 who has transmitted the particular printing job. The error information may contain the type of the error, the time of occurrence and the probable cause of the error. The user operating the client 1, based on the error information, can quickly take an appropriate action.

The process of operation of the shared print server control program and the shared print server control method according to this invention described above is executed by a CPU (central processing unit) included in the server 3 and the client 1 based on the shared print server control program according to the invention in collaboration with the operating system mounted on the server 3 and the client 1.

As explained above, the shared print server control program and the shared print server control method according to this invention can realize a smooth and rapid process of the printing job as viewed from the client side in the shared printer system without changing the standard function or the printing framework of the operating system.

What is claimed is:

1. A shared print server control program used for a shared printer system including a server connected with a printer and at least one client connected to the server through a network, realizing an operation of the shared printer system in such a manner that:
an additional spooler for assisting in the management of printing jobs is arranged on the server in addition to a standard spooler included in the operating system mounted on the server for managing the printing jobs based on the shared printer function; and
the additional spooler, upon sequential receipt of all the printing jobs transmitted from the client, cuts off the communication connection with the client without waiting for the end of the processing operation of the previously received printing jobs.

2. The shared print server control program according to claim 1,
wherein the additional spooler sequentially transfers the received printing jobs to the standard spooler.

3. The shared print server control program according to claim 1,
wherein only one of the standard spooler and the additional spooler is recognized exclusively as viewed from the client side.

4. The shared print server control program according to claim 1,
wherein the shared printer function of the operating system is set in an invalid state at the time of installing or starting the shared print server control program.

5. The shared print server control program according to claim 1,
wherein the validity or invalidity of the shared printer function of the operating system is monitored at the time of starting the shared print server control program.

6. The shared print server control program according to claim 5,
wherein upon detection of the validity of the shared printer function of the operating system, the communication function of the additional spooler is invalidated.

7. The shared print server control program according to claim 5,
wherein upon detection of the invalidity of the shared printer function of the operating system, the communication function of the additional spooler is validated.

8. The shared print server control program according to claim 1,
wherein after starting the shared print server control program, the validity or invalidity of the shared printer function of the operating system is continuously monitored.

9. The shared print server control program according to claim 8,
wherein upon detection of the validity of the shared printer function of the operating system, the communication function of the additional spooler is invalidated.

10. The shared print server control program according to claim 8,
wherein upon detection of the invalidity of the shared printer function of the operating system, the communication function of the additional spooler is validated.

11. The shared print server control program according to claim 1,
wherein the additional spooler monitors the printer status after starting the processing operation of a printing job and upon occurrence of a printer error during the processing operation of the printing job, the error information based on a predetermined protocol is notified to the client installed with a predetermined resident program.

12. A shared print server control method used for a shared printer system including a server connected with a printer and at least one client connected to the server through a network, comprising the steps of:
arranging on the server an additional spooler for assisting in the management of printing jobs in addition to a standard spooler included in the operating system mounted on the server for managing the printing jobs based on the shared printer function;
the additional spooler sequentially receiving all the printing jobs transmitted from the client to the server without waiting for the end of the processing operation of the previously received printing jobs; and
cutting off the communication connection with the client without delay after the additional spooler has sequentially received all the printing jobs transmitted from the client.

13. The shared print server control method according to claim 12, further comprising the step of:
the additional spooler sequentially transferring the received printing jobs to the standard spooler.

14. The shared print server control method according to claim 13, further comprising the step of:
the additional spooler monitoring the printer status after starting the processing of a printing job and upon occurrence of an error in the printer during the processing of the printing job, notifying the error information in accordance with a predetermined protocol to the client installed with a predetermined resident program.

15. The shared print server control method according to claim 12,
wherein only one of the standard spooler and the additional spooler is exclusively recognized as viewed from the client.
